(19) United States
(12) Patent Application Publication
(10) Pub. No.: US 2020/0033837 A1
(43) Pub. Date: Jan. 30, 2020

(54) COOLING SYSTEM AND METHOD FOR CRYPTOCURRENCY MINERS

(71) Applicant: Cube Hydro Partners, LLC, Bethesda, MD (US)

(72) Inventors: Walter Neal Simmons, Bahama, NC (US); Walter John Simmons, Martinsburg, WV (US); Connor Tinen, Brooklyn, NY (US)

(21) Appl. No.: 16/292,305

(22) Filed: Mar. 4, 2019

Related U.S. Application Data
(60) Provisional application No. 62/681,028, filed on Jun. 5, 2018.
(60) Provisional application No. 62/638,294, filed on Mar. 4, 2018.

(51) Int. Cl. G05B 19/4155

(52) U.S. Cl. CPC G05B 19/4155; G05B 2219/49216

(57) ABSTRACT

A data center comprises an enclosed space, a support disposed in the enclosed space, a plurality of cryptocurrency miners disposed on the support, and a barrier wall separating the enclosed space into a first portion on a relatively cool side and a second portion on a relatively warm side. The cryptocurrency miners each comprise a miner fan for circulating air from the first portion, and the cryptocurrency miners are each disposed so that air moved by the miner fan is exhausted into the second portion. A method of cooling a data center involves drawing relatively cool air into and through miners. Once the air is warmed inside the miners, the air is exhausted into a partitioned space.

### CROSS-REFERENCE TO RELATED APPLICATIONS

This application claims the benefits of U.S. Provisional Application No. 62/638,294 filed Mar. 4, 2018 by Walter Neal Simmons and entitled “Cooling System and Method for Cryptocurrency Miners” as well as U.S. Provisional Application No. 62/681,028 filed Jun. 5, 2018 by Walter Neal Simmons, Walter John Simmons, and Connor Tinen and entitled “Cooling System and Method for Cryptocurrency Miners” under 35 U.S.C. § 119(e), and the entire contents of these applications are expressly incorporated herein by reference thereto.

### FIELD OF THE INVENTION

The invention relates to a cooling system and method for cryptocurrency miners. The invention further relates to a data center and a method of cooling a data center.

### BACKGROUND OF THE INVENTION

Commercially available cryptocurrency mining equipment has vastly expanded companies' ability to scale their mining operations. Nevertheless, to be profitable, the choice and overall setup of the equipment is essential. As shown for example in FIG. 1, the miner 2 itself for example comprises a housing 4 with a control board (not shown), many application-specific microchips typically distributed among several circuit boards (not shown) inside housing 4, and at least one cooling fan 6 coupled to a front end 4a of housing 4 providing an air flow therein that is exhausted out a back end 4b of housing 4, and is provided with an associated power supply 8 which also has its own cooling fan 8a. Miner 2 achieves profitability measured based on equipment factors including the so-called hash rate as well as the power consumption of the miner.

Bitmain Technologies Inc.'s Antminer S9 Bitcoin Miner has emerged as a particularly popular design. Relying on 189 ASIC chips designed for bitcoin mining, along with a control board employing a fast, Dual ARM® Cortex®-A9 microprocessor, the Antminer S9 has a hash rate of 13-14 TeraHash per second (TH/s)±5%, power consumption of 1300-1340 W (depending on hash rate and assuming 25° C. ambient temperature), and two 12038 axial fans including a front fan with a speed of 6000 rpm (providing an estimated airflow at zero static pressure of about 210 CFM) and a rear fan with a speed of 4300 rpm (providing an estimated airflow at zero static pressure of about 175 CFM). Each Antminer S9 unit has a generally rectangular, aluminum housing and has overall dimensions of 350 mm (L)×135 mm (W)×158 mm (H). The unit is designed for an operating temperature range of 0° C.-40° C. Breaking down the various costs associated with these units, cooling is quite significant given that the fans must provide significant airflow because of the heat generation that occurs while the unit is operating. Each of the microchips is provided with aluminum alloy heat sinks for conducting heat away from the chips, while the high speed fans must constantly replace the heated air within the housing with fresh cooler air. Graphics processing units (GPUs) can be used in this application because the processors provide substantial calculating power, although other processors such as central processing units (CPUs) may be used.

The Antminer S9 is just one example of a cryptocurrency miner. It is quite expensive compared to many others available in the commercial market, but offers efficiency that others cannot meet at their price points.

What is clear from the various cryptocurrency miner options on the market is that their installation can vary considerably among users. One significant variable is the method employed for cooling in the vicinity of the miners. In particular, the most desirable facilities have access to relatively inexpensive electricity and low operating temperatures. If air conditioning equipment must be used to provide the relatively cooler air to circulate through the miners, or large exhaust-type fans are employed to introduce air from the outside into an enclosed space (such as a building) where racks of miners may be disposed, costs are increased. Depending on the number of miners used in an operation, which could vary from one to a thousand or more, the design of the cooling system and method becomes more important. In other words, an investment of hundreds of thousands of dollars in miners for a single operation must be adequately protected, in part, by protecting the equipment from failures, or shutdowns, due to overheating. Thus, in order to scale operations, the overall layout of the miners within a given space must be carefully considered.

In sum, there exists a need for convective cooling systems and methods for efficiently handling heat transfer away from cryptocurrency miners.

### SUMMARY OF THE INVENTION

A data center includes an enclosed space, a support disposed in the enclosed space, a plurality of cryptocurrency miners disposed on the support, and a barrier wall separating the enclosed space into a first portion on a relatively cool side and a second portion on a relatively warm side. The cryptocurrency miners each have a miner fan for circulating air from the first portion. The cryptocurrency miners are each disposed so that air moved by the miner fan is exhausted into the second portion. At least one exhaust fan may be provided for exhausting air from the second portion.

In some embodiments, the enclosed space may be a shipping container. The support may be a rack assembly. In addition, louvers may be provided for permitting air circulation into the first portion. The louvers may include at least one barrier for preventing foreign objects from entering the enclosed space. The at least one barrier may be a screen, and the screen may be configured and dimensioned to prevent birds from entering the enclosed space. The louvers may include at least one panel filter for removing airborne particulate and coolant mist from air entering the enclosed space.

A temperature difference between the first portion and the second portion may be at least 10° C. or at least 20° C. during operation of the miners.

The cryptocurrency miners may be configured to mine Bitcoin.

The data center may further include an aperture for permitting air to transfer from the second portion to the first portion, and the aperture may permit control of relative humidity in the first portion.

The data center may further include a second barrier wall separating the enclosed space into a third portion on a relatively cool side and the second portion on a relatively warm side, wherein the third portion is distinct from the first portion.

A data center may include: an enclosed space; a first support disposed in the enclosed space; a plurality of cryptocurrency miners disposed on the first support; a second support disposed in the enclosed space; a plurality of cryptocurrency miners disposed on the second support; a first barrier wall separating the enclosed space into a first portion on a relatively cool side and a second portion on a relatively warm side; a second barrier wall separating the enclosed space into a third portion on a relatively cool side and the second portion on a relatively warm side; wherein the cryptocurrency miners on the first support each comprise a miner fan for circulating air from the first portion; wherein the cryptocurrency miners on the second support each comprise a miner fan for circulating air from the third portion; and wherein the cryptocurrency miners are each disposed so that air moved by the miner fan is exhausted into the second portion.

A method of cooling a data center with a plurality of cryptocurrency miners, and with each miner having a miner fan, may include: disposing the miners in an enclosed space; drawing relatively cool air into the enclosed space on a first side of a barrier disposed therein; operating the miner fans to draw the relatively cool air into and through the miners, with the relatively cool air being warmed by convective heat transfer inside each miner, and the relatively cool air thereby being warmed to become relatively warm air; and exhausting the relatively warm air on a second side of the barrier opposite the first side. The method may further include drawing the relatively warm air out of the second side of the enclosed space using at least one exhaust fan.

In some embodiments, the relatively cool air may be drawn into the enclosed space through louvers. The louvers may include at least one barrier for preventing foreign objects from entering the enclosed space.

The method may further include: removing airborne particulate and coolant mist from air entering the enclosed space by passing the air through at least one panel filter.

A temperature difference between the first side of the barrier and the second side of the barrier may be at least 10° C. or at least 20° C. during operation of the miners.

In the method, the cryptocurrency miners may be configured to mine Bitcoin.

The method may further include: disposing the miners substantially on the first side; disposing the miners substantially on the second side; disposing the miners intermediate the first side and the second side; or disposing the miners to protrude into the first side and the second side.

The method also may further include: recirculating the relatively warm air to the first side. The relative humidity of the relatively cool air on the first side may be adjusted when the relatively warm air is recirculated to the first side. A static pressure difference between the first side and the second side may cause relatively warm air from the second side to flow through an opening into the first side. The recirculating may occur without mechanical air handling.

The method also may further include: drawing relatively cool air into the enclosed space on a first side of a second barrier disposed therein; operating the miner fans to draw the relatively cool air into and through the miners, with the relatively cool air being warmed by convective heat transfer inside each miner, and the relatively cool air thereby being warmed to become relatively warm air; and exhausting the relatively warm air on a second side of the second barrier opposite the first side; wherein the relatively warm air is disposed between the second side of the first barrier and the second side of the second barrier.

Also disclosed is a data center that includes an enclosed space, a support disposed in the enclosed space, a plurality of data loggers disposed on the support, and a barrier wall separating the enclosed space into a first portion on a relatively cool side and a second portion on a relatively warm side. The data loggers each comprise a fan for circulating air from the first portion therein. The data loggers are each disposed so that air moved by the at least one fan is expelled into the second portion.

In addition, a method of cooling a data center includes: flowing relatively cool air from a first side of a barrier through a plurality of data loggers each comprising a fan, the relatively cool air warmed by convective heat transfer inside each data logger, and the relatively cool air thereby being warmed to relatively warm air; and discharging the relatively warm air through each data logger and on a second side of the barrier opposite the first side.

### BRIEF DESCRIPTION OF THE DRAWINGS

Preferred features of the inventions are disclosed in the accompanying drawings, wherein:

FIG. 1 is a front perspective view of an embodiment of a prior art cryptocurrency miner;

FIG. 2 is a front perspective view of an embodiment of a data center;

FIG. 3 is a partial front perspective view of the data center of FIG. 2 with the roof removed from the container thereof so as to provide a view inside the data center;

FIG. 4 is another partial front perspective view of the data center of FIG. 2 with the roof and exhaust fans removed from the container thereof so as to provide a view inside the data center;

FIG. 5 is another partial front perspective view of the data center of FIG. 2 with the roof, exhaust fans, and louvers removed from the container thereof so as to provide a view inside the data center;

FIG. 6 is another partial front perspective view of the data center of FIG. 2 with the louvers removed from the container thereof so as to provide a view inside the data center;

FIG. 7 is another partial front perspective view of the data center of FIG. 2 with the roof removed from the container thereof so as to provide a view inside the data center;

FIG. 8 is another partial front perspective view of the data center of FIG. 2 with the roof and exhaust fans removed from the container thereof so as to provide a view inside the data center;

FIG. 9 is another partial front perspective view of the data center of FIG. 2 with the roof, exhaust fans, and louvers removed from the container thereof so as to provide a view inside the data center;

FIG. 10 is a partial top perspective view of the data center of FIG. 2 with the roof and exhaust fans removed from the container thereof so as to provide a view inside the data center;

FIG. 11 is a front view of the data center of FIG. 2;

FIG. 12 is a partial front view of the data center of FIG. 2 with the louvers removed from the container thereof so as to provide a view inside the data center;

FIG. 13 is a rear perspective view of the data center of FIG. 2;

FIG. 14 is a partial rear perspective view of the data center of FIG. 2 with the roof and exhaust fans removed from the container thereof so as to provide a view inside the data center;

FIG. 15 is another partial rear perspective view of the data center of FIG. 2 with the roof and exhaust fans removed from the container thereof so as to provide a view inside the data center;

FIG. 16 is another partial rear perspective view of the data center of FIG. 2 with the roof, exhaust fans, and back side removed from the container thereof so as to provide a view inside the data center;

FIG. 17 is another partial rear perspective view of the data center of FIG. 2 with the roof, exhaust fans, and back side removed from the container thereof so as to provide a view inside the data center;

FIG. 18 is a rear view of the data center of FIG. 2;

FIG. 19 is another partial rear perspective view of the data center of FIG. 2 with the roof, exhaust fans, and back side removed from the container thereof so as to provide a view inside the data center;

FIG. 20 is a front perspective view of the rack assembly with cryptocurrency miners of the data center of FIG. 2;

FIG. 21 is a rear perspective view of the rack assembly with cryptocurrency miners of the data center of FIG. 2;

FIG. 22 is a front view of the rack assembly with cryptocurrency miners and barrier wall of the data center of FIG. 2;

FIG. 23 is a rear view of the rack assembly with cryptocurrency miners and barrier wall of the data center of FIG. 2;

FIG. 24 is a front view of a first embodiment of a rack with cryptocurrency miners and barrier wall of the data center of FIG. 2;

FIG. 25 is a front perspective view of the first embodiment of a rack with cryptocurrency miners and barrier wall of the data center of FIG. 2;

FIG. 26 is a partial front perspective view of the first embodiment of a rack with cryptocurrency miners and barrier wall of the data center of FIG. 2;

FIG. 27 is a partial rear perspective view of the first embodiment of a rack with cryptocurrency miners and barrier wall of the data center of FIG. 2;

FIG. 28 is a front view of a second embodiment of a rack with cryptocurrency miners and barrier wall of the data center of FIG. 2;

FIG. 29 is a front perspective view of the second embodiment of a rack with cryptocurrency miners and barrier wall of the data center of FIG. 2;

FIG. 30 is a rear perspective view of the second embodiment of a rack with cryptocurrency miners and barrier wall of the data center of FIG. 2;

FIG. 31 is a partial front perspective view of the second embodiment of a rack with cryptocurrency miners and barrier wall of the data center of FIG. 2;

FIG. 32 is a partial rear perspective view of the second embodiment of a rack with cryptocurrency miners and barrier wall of the data center of FIG. 2;

FIG. 33 is a rear view of the barrier wall of the first embodiment of a rack with cryptocurrency miners and barrier wall of the data center of FIG. 2;

FIG. 34 is a rear view of the barrier wall of the second embodiment of a rack with cryptocurrency miners and barrier wall of the data center of FIG. 2;

FIG. 35 is a partial front perspective view of shelving of the first embodiment of the rack of the data center of FIG. 2, with brackets for receiving a plurality of miners;

FIG. 36 is a side perspective view of the power cable trough of the rack assembly of the data center of FIG. 2;

FIG. 37 is a partial front perspective view of a data center with the roof and louvers removed from the container thereof so as to provide a view inside the data center;

FIG. 38 is a front perspective view of the rack assembly with cryptocurrency miners of the data center of FIG. 37;

FIG. 39 is a front perspective view of the first embodiment of a rack with cryptocurrency miners and barrier wall of the data center of FIG. 37;

FIG. 40 is a front perspective view of the second embodiment of a rack with cryptocurrency miners and barrier wall of the data center of FIG. 37;

FIG. 41 is a front view of the first embodiment of a rack with cryptocurrency miners and barrier wall of the data center of FIG. 37;

FIG. 42 is a front view of the second embodiment of a rack with cryptocurrency miners and barrier wall of the data center of FIG. 37;

FIG. 43 is a is a front perspective view of another embodiment of a data center;

FIG. 44 is a partial front perspective view of the data center of FIG. 43 with the roof and exhaust fans removed from the container thereof so as to provide a view inside the data center;

FIG. 45 is another partial front perspective view of the data center of FIG. 43 with the roof, exhaust fans, and front side of louvers removed from the container thereof so as to provide a view inside the data center;

FIG. 46 is a partial rear perspective view of the data center of FIG. 45 with the roof, exhaust fans, and rear side of louvers removed from the container thereof so as to provide a view inside the data center;

FIG. 47 is a view of a first side of a first rack assembly with cryptocurrency miners and barrier wall of the data center of FIG. 45;

FIG. 48 is a view of a second side of the first rack assembly with cryptocurrency miners and barrier wall of the data center of FIG. 45;

FIG. 49 is a view of a first side of a second rack assembly with cryptocurrency miners and barrier wall of the data center of FIG. 45; and

FIG. 50 is a view of a second side of the second rack assembly with cryptocurrency miners and barrier wall of the data center of FIG. 45.

### DETAILED DESCRIPTION OF THE PREFERRED EMBODIMENTS

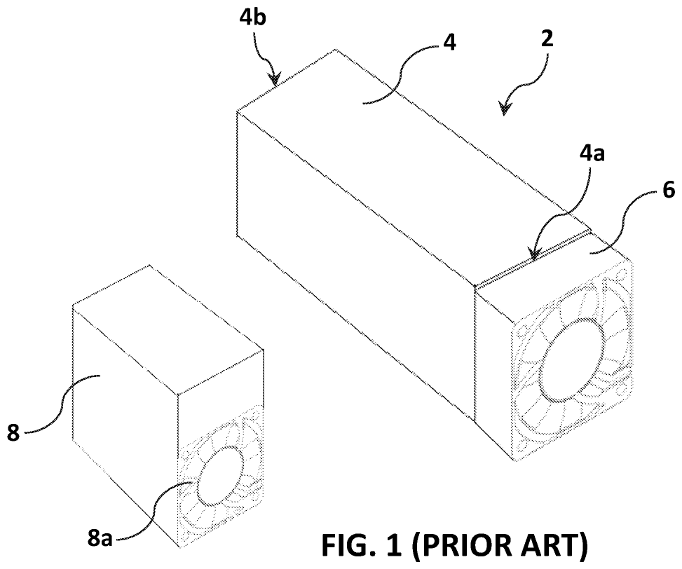

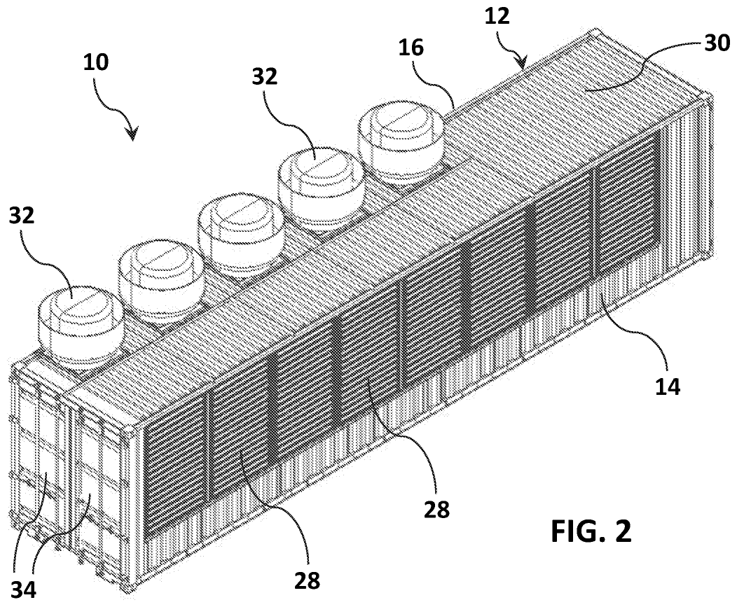

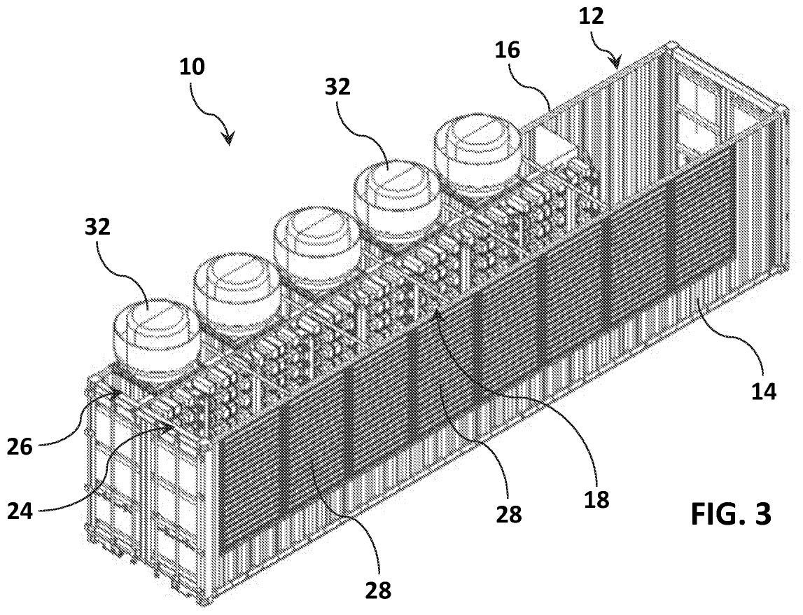

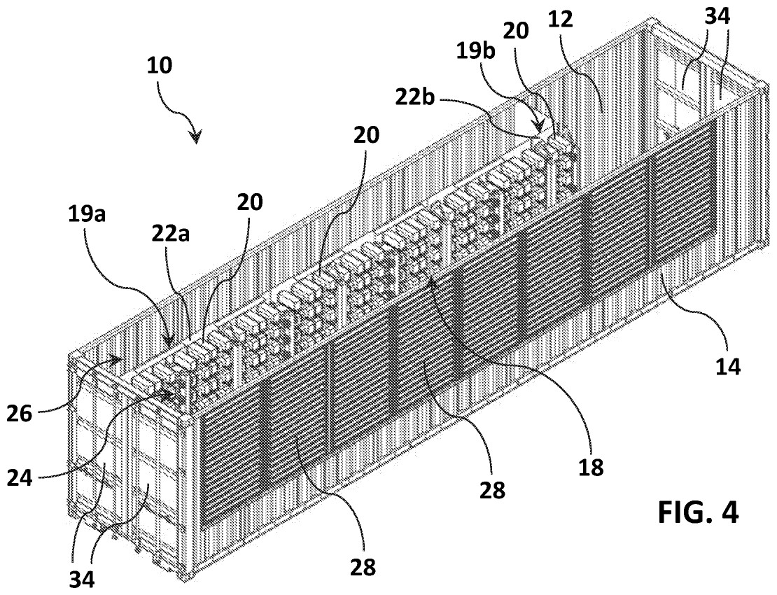

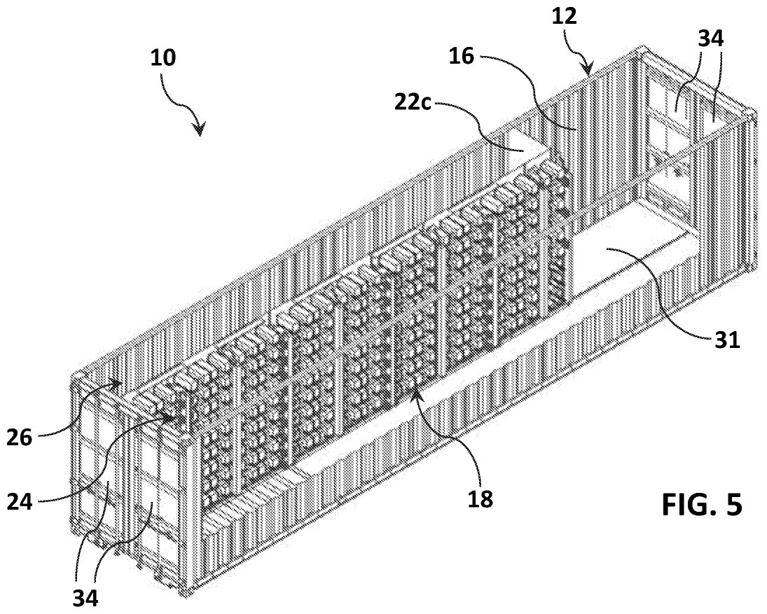

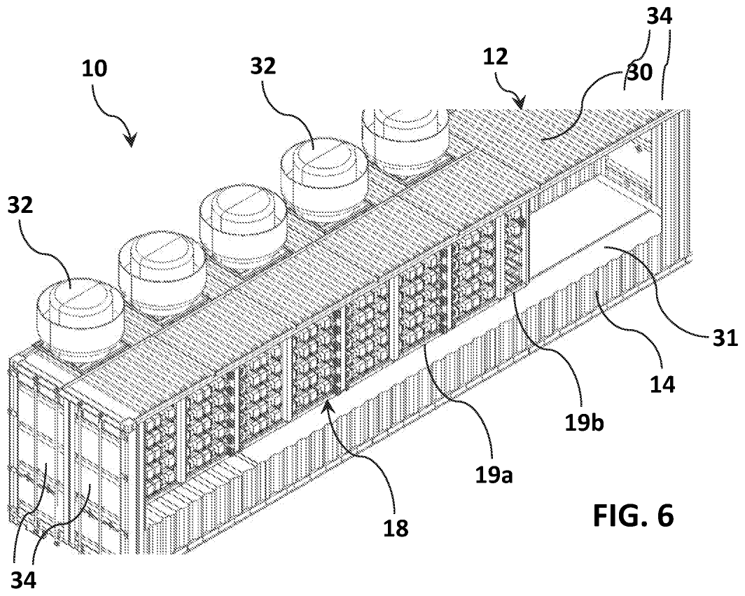

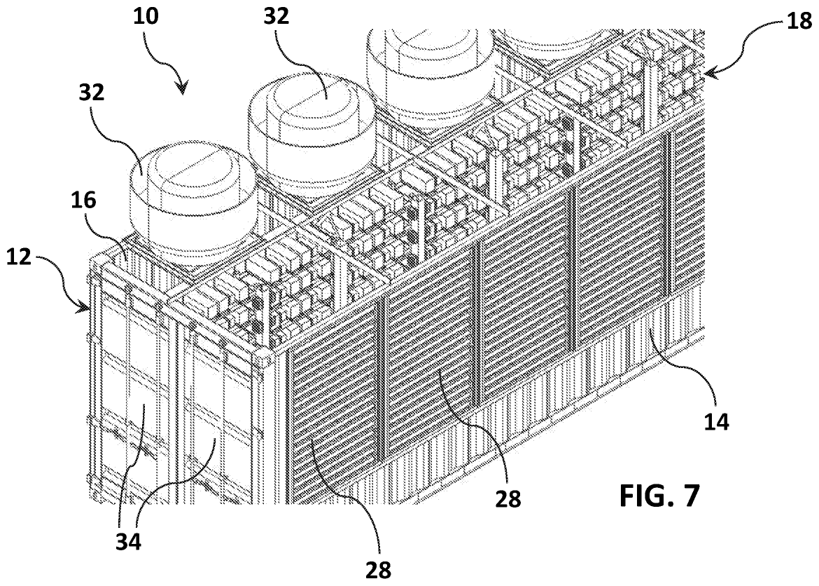

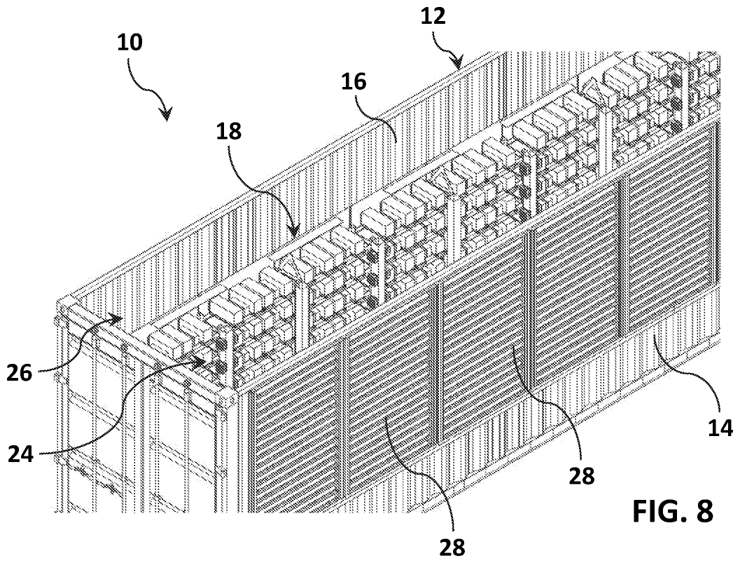

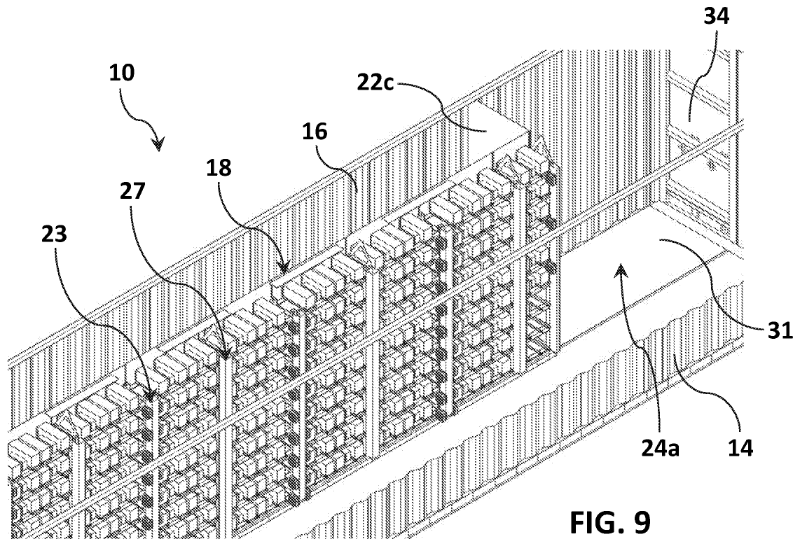

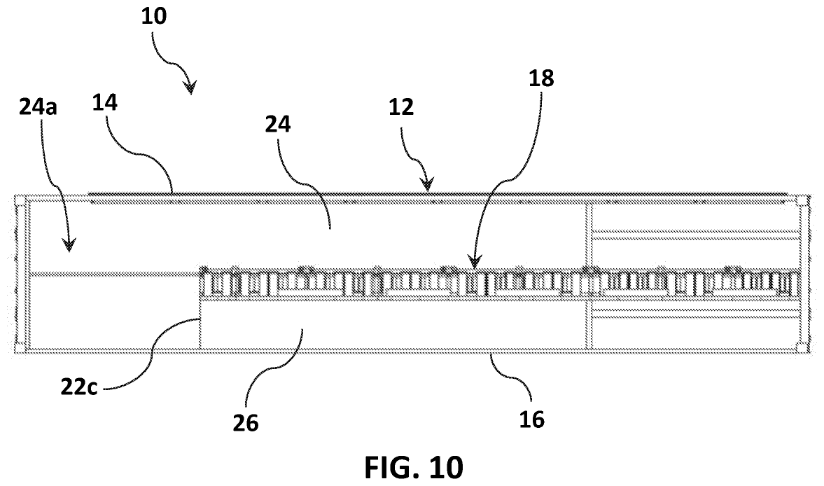

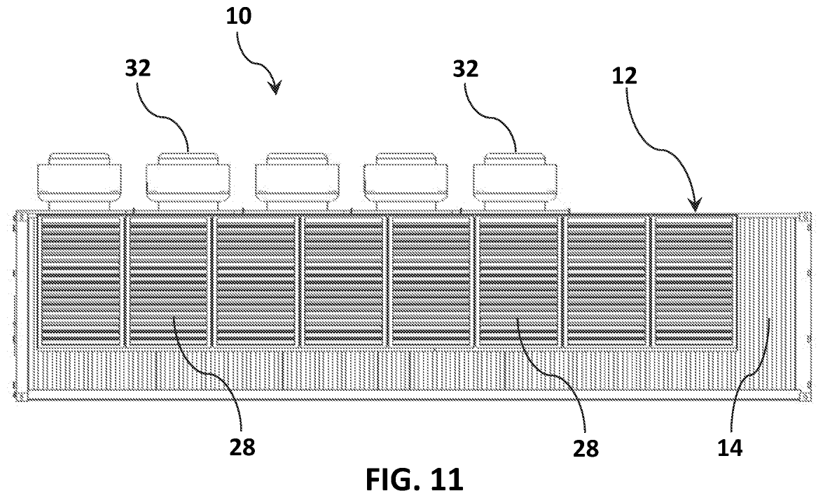

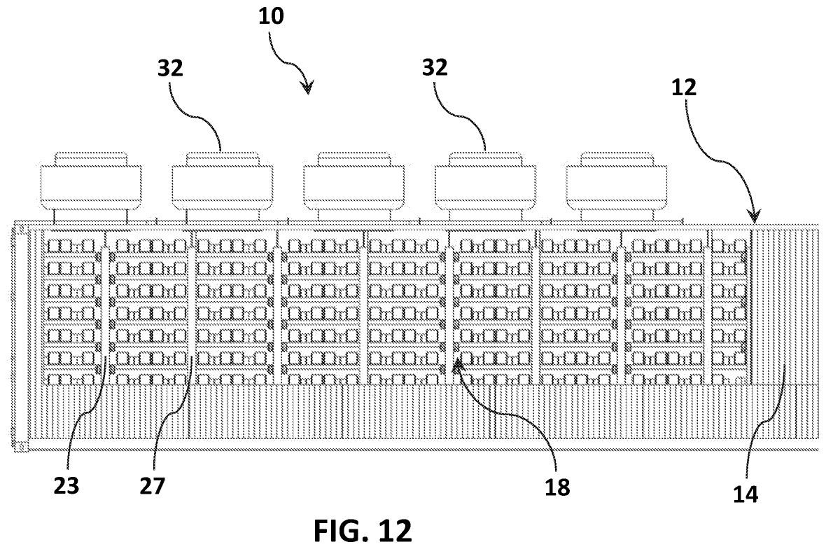

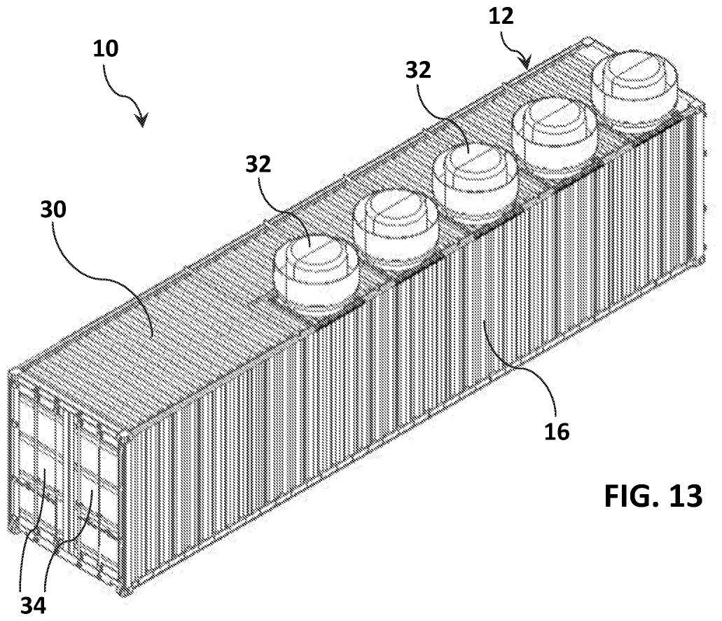

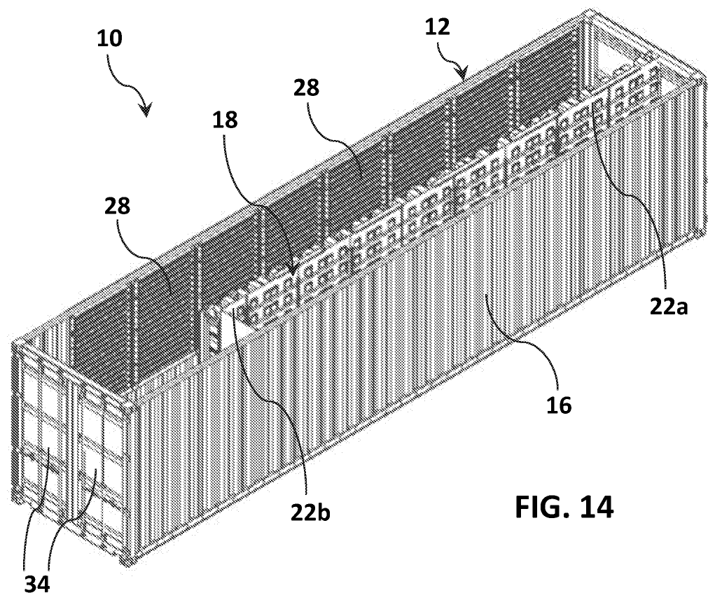

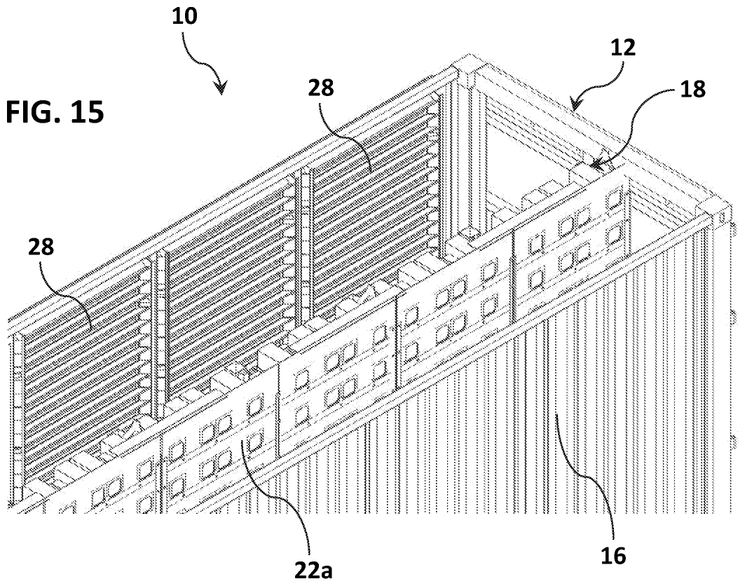

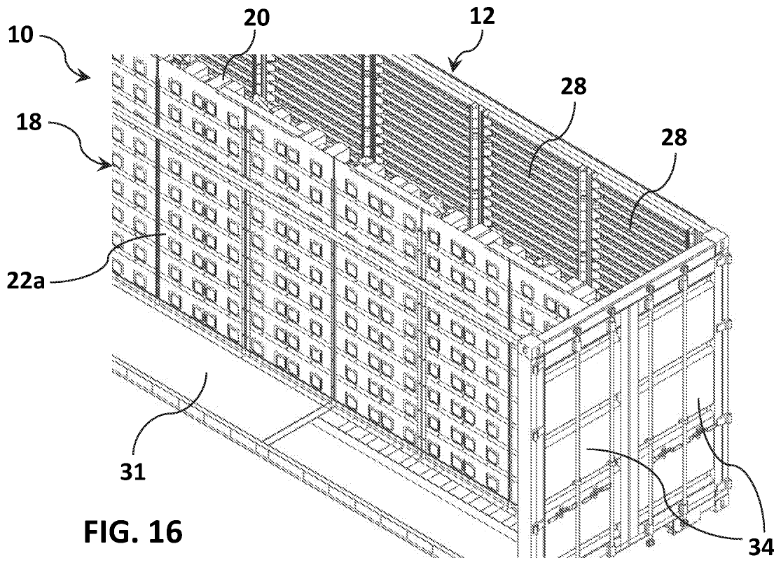

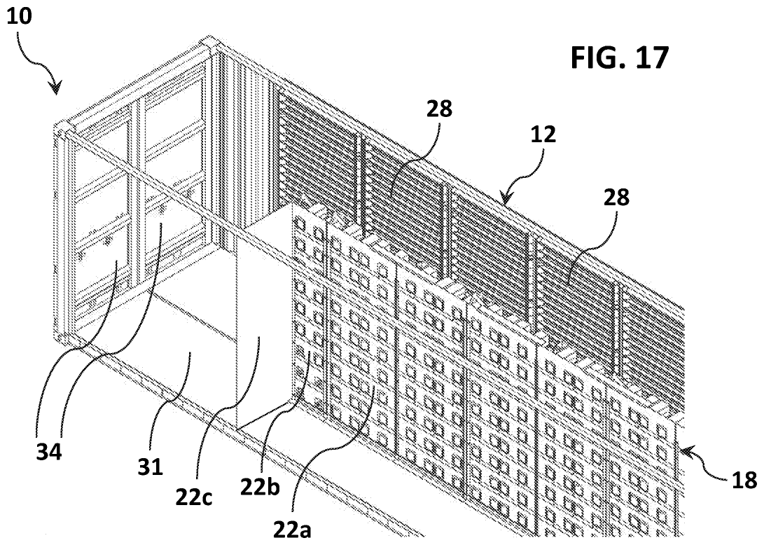

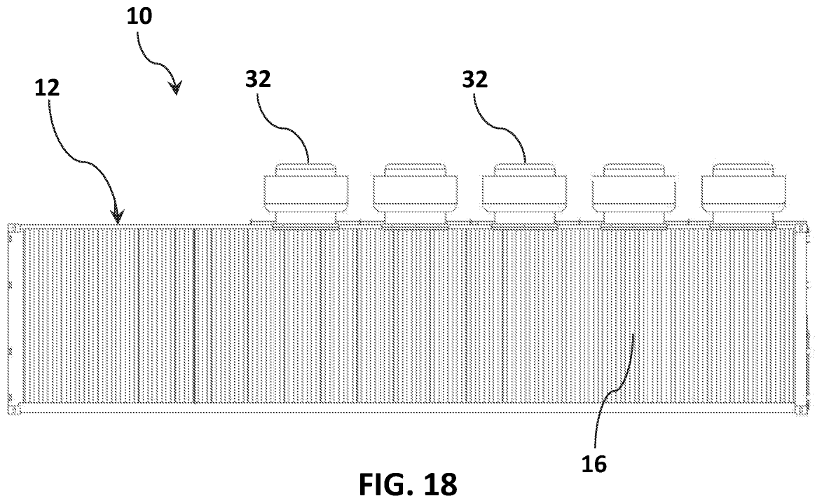

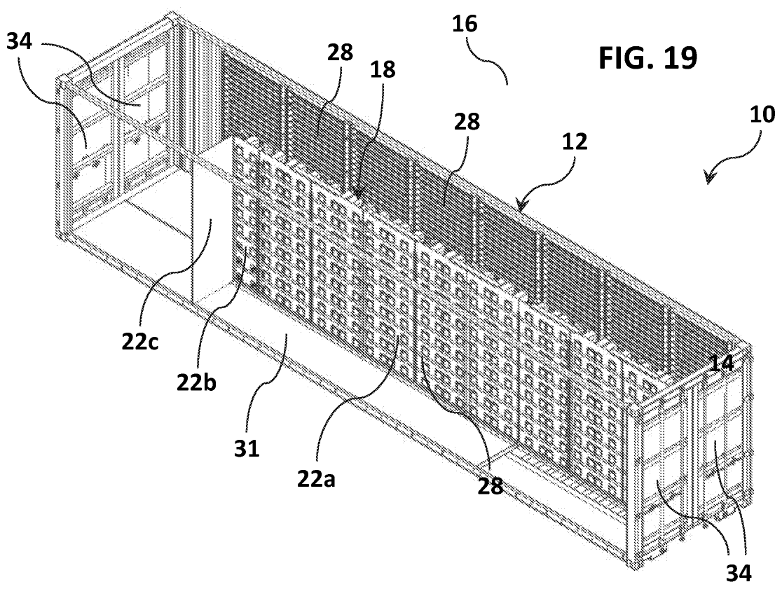

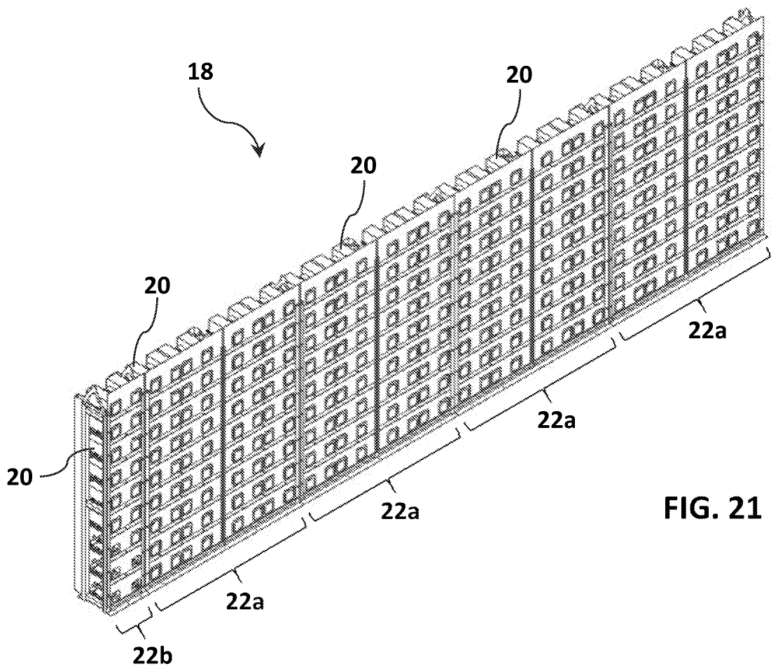

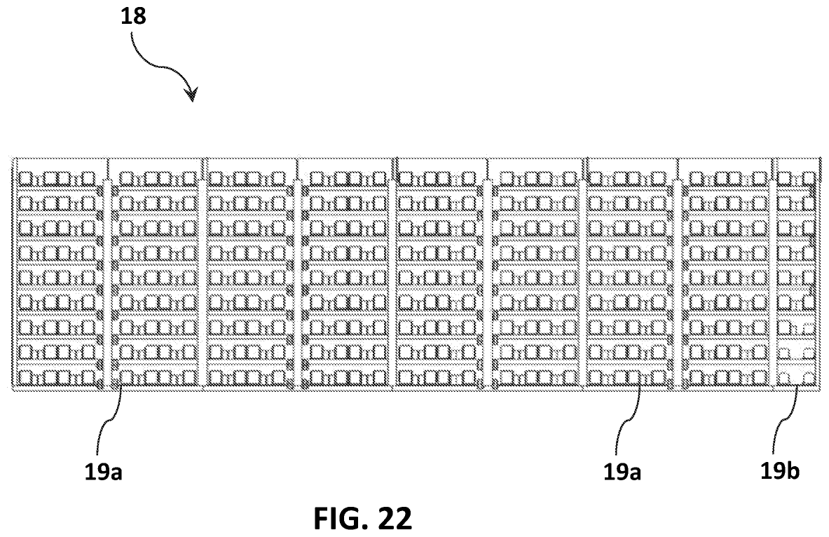

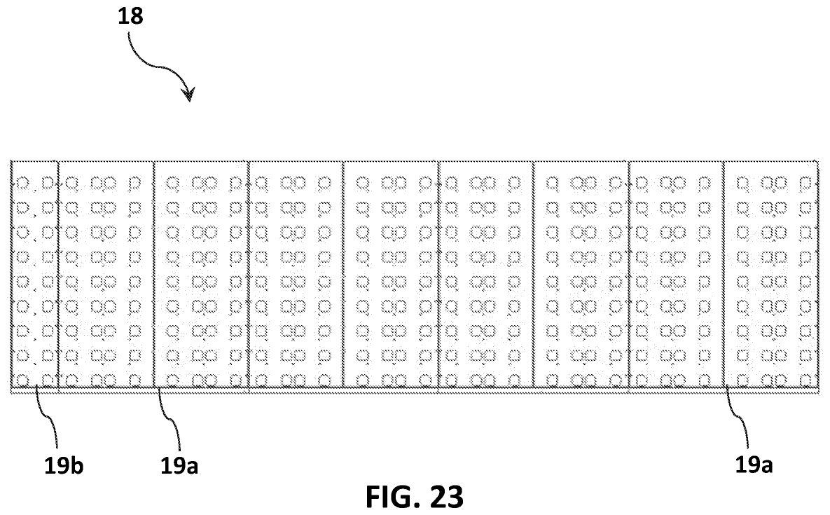

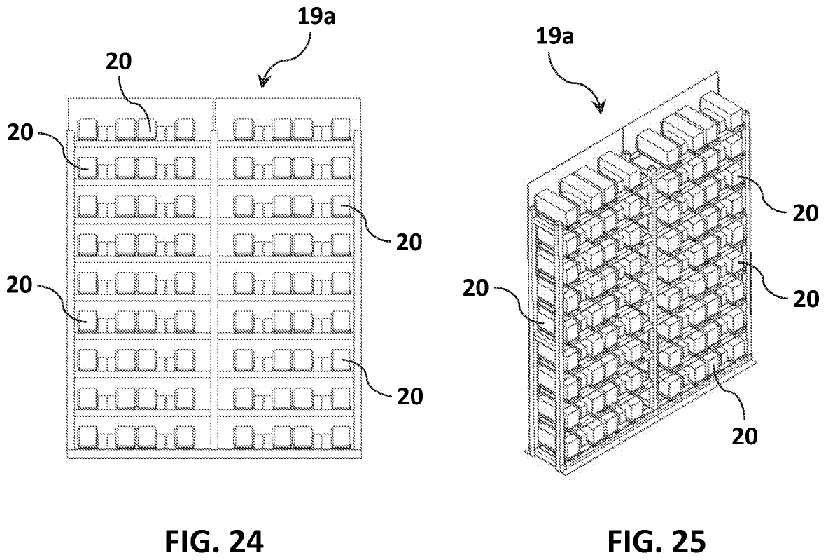

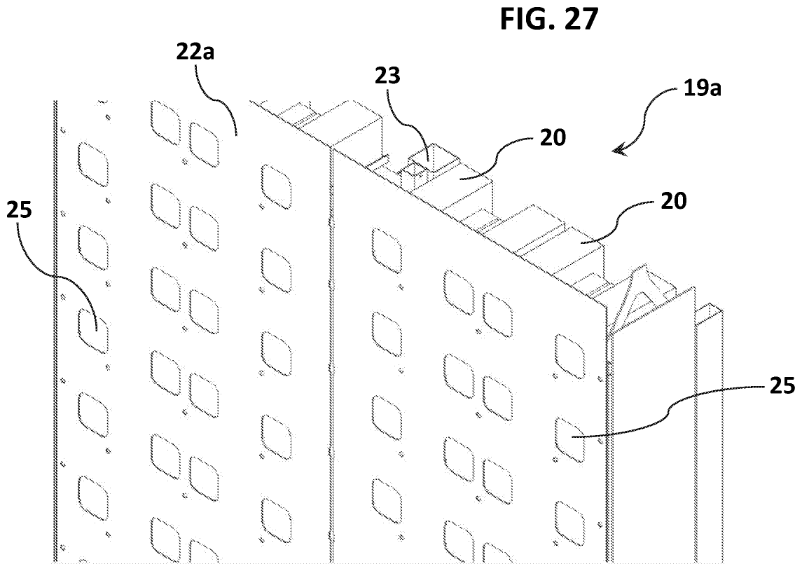

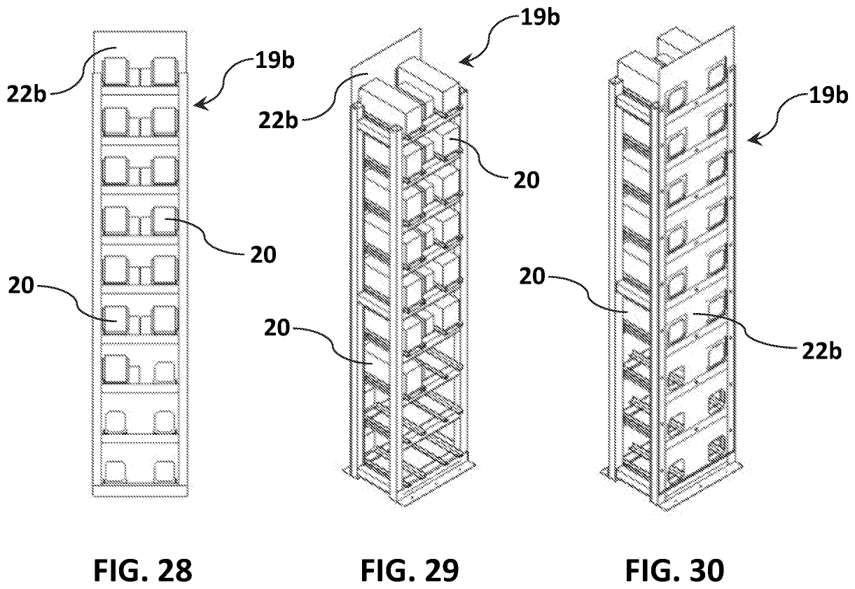

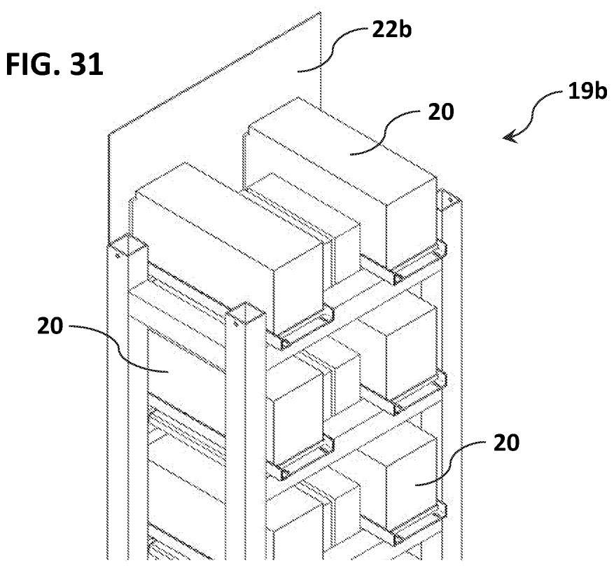

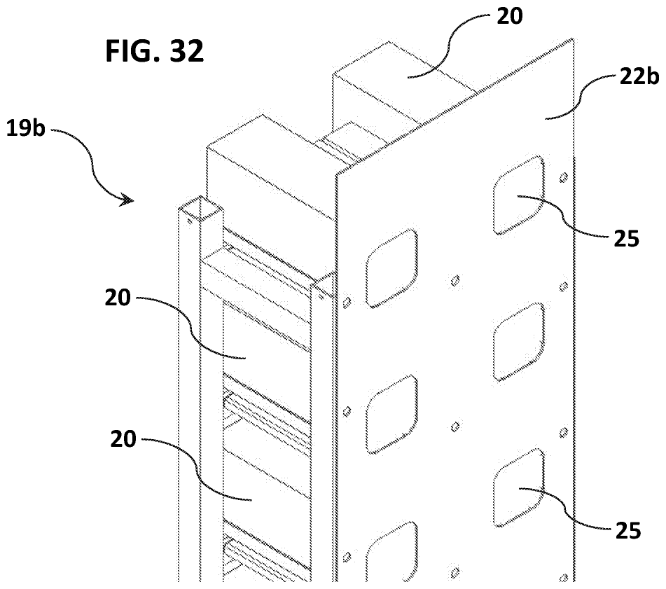

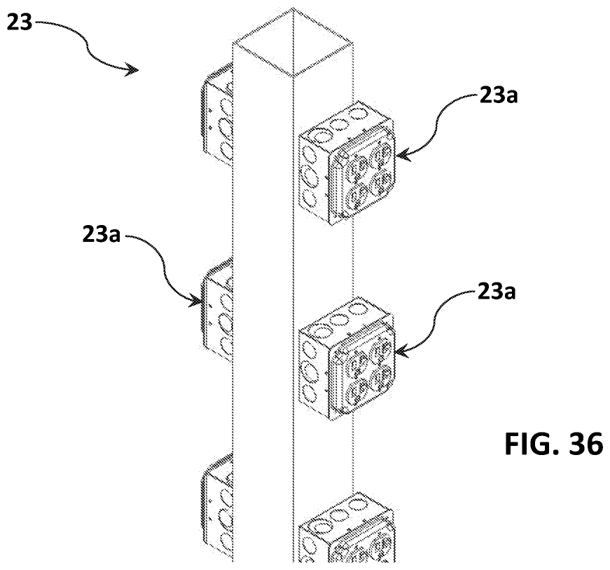

Turning to FIGS. 1-36, in a preferred, exemplary embodiment, a data center 10 comprises a container 12 with a front side or wall 14, a back side or wall 16, and a rack assembly 18 with at least one rack 19a, 19b. Each rack 19a, 19b preferably has at least one computing unit 20, which may be a miner or other computer, a processing unit, or a data logger, mounted thereon, a barrier wall 22a, 22b, and a power cable trough 23 with power receptacles 23a for coupling to miners 20 so as to provide power thereto. A network cable trough 27 (such as Panduit® vertical cable management systems) also may be provided for delivering network connections to each miner 20.

Barrier walls 22a, for example, may be provided in sections 22a₁, 22a₂ for ease of installation. Similarly, barrier walls 22b may be provided in sections 22b₁, 22b₂, with section 22b₂ having a smaller width than section 22b1. Preferably, barrier walls 22a, 22b are disposed generally parallel to front side 14 and, along with a barrier wall 22c disposed generally transverse to front side 14 and back side 16, separate a front section 24 where relatively cool air is present from a rear section 26 where relatively warm air is present. A portion of front side 14 comprises a plurality of louvers 28 for permitting air intake. Container 12 further includes a roof 30, a floor 31, at least one fan 32 operated as an exhaust fan and disposed on roof 30, and lockable doors 34 on both ends thereof.

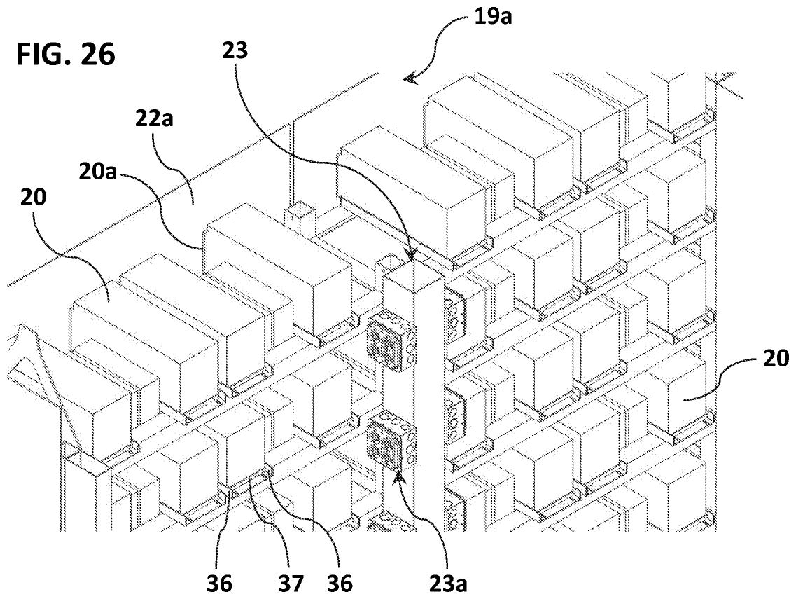

Preferably, barrier walls 22a, 22b, 22c together form a partition (which for example may be made of ⅛ inch thick aluminum sheet) that creates a floor-to-ceiling seal between the relatively cold front section 24 and the relatively warm rear section 26. Rack assembly 18 may be sealed to floor 31 and roof 30, such as by bolting and/or use of foil tape and/or use of sprayable, expandable foam. In a preferred exemplary embodiment, as shown for example in FIG. 26, a foam rubber seal 20a is provided between each miner 20 and partitions 22a, 22b, 22c to provide a seal therebetween and around each opening 25.

In an exemplary embodiment, exhaust fan 32 is a belt drive, upblast, centrifugal, roof exhaust fan, providing air flow of 13,750 cfm with the fan operating at 905 RPM driven by a 5 hp motor at 1725 RPM, which for example requires a roof opening of 30-40 inches×30-40 inches. Preferably, exhaust fans 32 direct relatively warm air out of rear section 26 and away from front intake wall 14 with louvers 28, while also directing noise from components in container 12 upward and away from neighboring areas. Also, exhaust fans 32 preferably minimize positive pressure in rear section 26.

In the exemplary embodiment, louvers 28 are weather louvers designed to protect air intake on front side 14 of container 12. Furthermore, louvers 28 may provide security and privacy so that unauthorized individuals cannot enter container 12 or readily inspect the contents therein in detail. Preferably, louvers 28 incorporate drain gutters in the head member and horizontal blades thereof to channel water to the jambs where water is further channeled through vertical downspouts and out at a sloped sill. Louvers 28 also preferably are designed to withstand wind loads as high as 25 PSF.

In a preferred exemplary embodiment, each louver 28 is fitted with an industrial grade, impingement type panel filter in order to remove large airborne particulate and water mist (such as from rain) from the airstream entering front section 24 of container 12. Such panel filters preferably are washable and durable, and create a low resistance to airflow. Moreover, such panel filters may have a rated airflow of 350 fpm, a recommended airflow range of 300 to 500 fpm, a dust holding capacity at 1 inch thick of 68 grams per square foot and at 2 inches thick of 97 grams per square foot, an average arrestance at 1 inch thick of 43% at rated airflow and at 2 inches thick of 53% at rated airflow, and a recommended final resistance of 0.50 inch W.G.

In one preferred exemplary embodiment, louvers 28 are mounted within a steel frame and are about six inches deep. On the side of louvers 28 facing relatively cool front section 24, a series of screens and/or filters may be coupled to louvers 28 (and held in position for example within an aluminum channel). For example, a bird/critter screen may be provided abutting an insect screen abutting a panel filter for particulate and mist, with the panel filter provided closest to section 24. Screens and filters preferably are formed of metal to facilitate washing. In general, louvers 28 are configured and dimensioned to permit desired airflow into container 12 while keeping foreign objects (such as animals, insects, and dirt) and water out of container 12. Advantageously, the intake area provided by louvers 28 may be configured and dimensioned such that air enters front section 24 at sufficiently low velocity to readily permit filtration thereof.

In the exemplary embodiment, an airflow of 60-75,000 cfm may be achieved through louvers 28 with their screens and/or filters. Louvers 28 with their screens and/or filters are selected to minimize pressure drop across them, so that fans 6 on miners 20 are not overloaded.

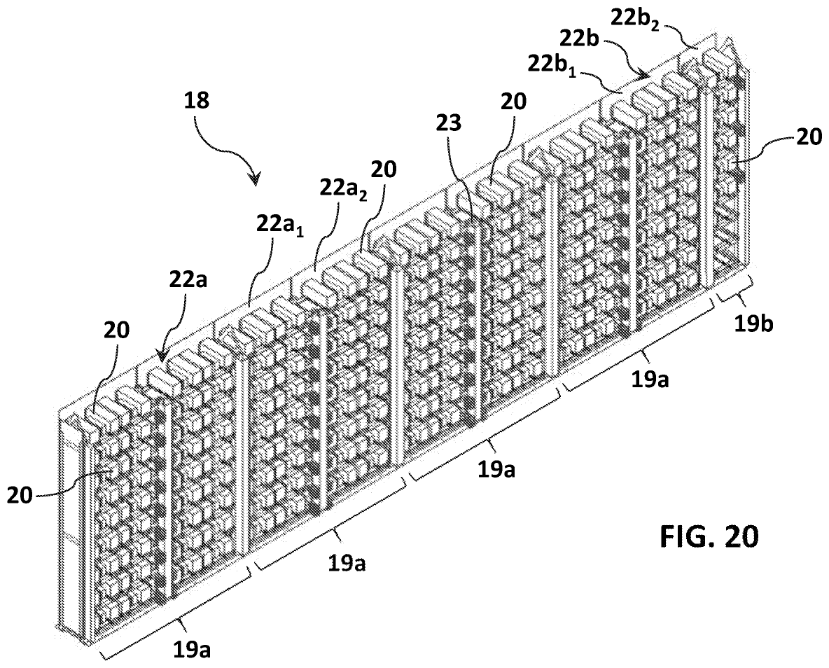

In one preferred exemplary embodiment, rack assembly 18 is formed of a plurality of racks 19a, 19b (which for example may be made of aluminum tubing and aluminum sheets) that are all coupled together. In particular, racks 19a may have nine shelves, with each shelf accommodating eight miners 20 with their associated power supplies 8 (not shown). A single rack 19b may have nine shelves each accommodating two miners 20 along with their associated power supplies 8. As shown for example in FIG. 20, rack assembly 18 may be formed of four racks 19a and one rack 19b whose respective barrier walls 22a, 22b together with roof 30, floor 31, a door 34, and a barrier wall 22c form enclosed rear section 26. Thus, in the exemplary embodiment, an array of three hundred and six (306) cryptocurrency miners 20 are distributed in thirty-four (34) columns and nine (9) rows, arranged on rack assembly 18 and protruding through barrier walls 22a, 22b. Each rack 19a, for example, may be about 8 feet high and 8 feet wide. If it is assumed, for example, that each fan 6 of each miner 20 pulls about 200 CFM of air, then a total of about 61,000 CFM of air flow is achieved.

Each barrier wall 22a, 22b has a plurality of openings 25 that each are in communication with a back end 4b of a housing 4 of a miner 20, so that relatively cool air from front section 24 may be (1) drawn into each housing 4 by the fan 6 coupled thereto, (2) then cools components of miner 20, and (3) then is exhausted into relatively warm rear section 26 where the warmed air ultimately may be exhausted through exhaust fans 32 disposed on roof 30 and preferably spanning substantially the entire length of rear section 26 from proximate door 34 to proximate barrier wall 22c.

Preferably, relatively cool front section 24 includes a region 24a for accommodating control cabinet(s) and electrical panel boards for data center 10, because such components preferably are maintained in a relatively cool environment.

Miners 20 for example comprise Antminer S9 Bitcoin Miners, and are disposed on rack assembly 18 within a “High Cube” shipping container 12. Such a container has exterior dimensions of 40 feet (L)×8 feet (W)×9 feet six inches (H), and interior dimensions of 39 feet 5 inches (L)×7 feet 8 inches (W)×8 feet 10 inches (H). The container is generally formed of 14-gauge corrugated steel panels as well as 1⅛ inch thick marine plywood flooring on its interior. In an alternate exemplary embodiment, a standard height shipping container (rather than a High Cube), one foot shorter in internal height, is used for container 12. In yet another alternate embodiment, container 12 may be a smaller shipping container such as with exterior dimensions 20 feet (L)×8 feet (W)×8 feet or 8 feet 6 inches (H). An in another alternate, exemplary embodiment, an intermodal container of another size may be used such as a High Cube shipping container 12 with exterior dimensions of 53 feet (L)×8 feet six inches (W)×9 feet six inches (H), and interior dimensions of 52 feet 5 inches (L)×8 feet 2 inches (W)×8 feet 111 inches (H), or a container of a smaller or larger size which for example may be a custom size. Other structures that may provide an enclosed space or container 12 for data center 10, for example, include detachable moving trailers or semi-trailers (such as the enclosed cargo space of a conventional, 18-wheeler semi-trailer truck with dimensions 28 feet (L)×8 feet (W)×9 feet (H)), panel or multi-stop trucks, or other portable structures such as PODS® containers (which for example may have dimensions 7 feet (L)×7 feet (W)×8 feet (H), 12 feet (L)×8 feet (W)×8 feet (H), or 16 feet (L)×8 feet (W)×8 feet (H)). Preferably, containers 12 are portable and provide weatherproofing so as to protect contents therein.

Container 12 advantageously provides sufficient width to be able to accommodate miners 20 and associated power supplies and also provides sufficient height to accommodate access for installation and maintenance. Furthermore, container 12 advantageously provides (1) a structure in which to support the various components of data center 10, (2) protection of those components from the elements such as weather that otherwise could adversely affect the components' operation, and importantly (3) an ability to transport data center from one location to another. As for the latter, data center 10 may be fabricated in one location and then transported by land, air, and/or sea to a delivery location. Such transportability for example permits all or portions of data center 10 (such as rack assemblies 18 and louvers 20) to be pre-fabricated before being shipped to a site (such as a hydroelectric plant) for final installation and operation.

Preferably, cryptocurrency miners 20 employ microchips, but no hard drive, so miners 20 are more tolerant to exposure to cold temperatures.

The design life of an individual miner 20, for example, only may be three years before replacement becomes necessary for example due to obsolescence (e.g., faster technology becomes available) or wear (having been operated for its design life and/or exposed to varying temperatures which impact the operational life). Thus, the modular design of data center 10 facilitates maintenance and, when necessary, removal and/or replacement of individuals miners 20.

Data center 10 is designed to advantageously separate relatively cool air from relatively warm air proximate miners 20. In other words, each of the cryptocurrency miners 20, as previously discussed, includes at least one fan, e.g., a fan 6 coupled to a front end 4a of a miner housing 4, to provide a flow of cool air through and out the back end 4b of miner housing 4. Cool air enters container 12 through louvers 28 and is drawn into each data miner 20 in front section 24. The air then cools the microcircuitry (and heat sinks) in miner 20, and then is expelled through its rear side to rear section 26. Barrier 22 provides a solid wall between front and rear sections, 24, 26, respectively, so that relatively warm air expelled into section 26 cannot recirculate into section 24. The relatively warm air, which potentially could reach 60-70° C., is expelled either through louvers (not shown but preferably the same as louvers 28) on the back side 16 or, in a preferred embodiment, through at least one exhaust fan 32 disposed on roof 30.

Power supplies 8 for miners 20 also generate a limited amount of heat. However, in the exemplary embodiment fans 8a of power supplies 8 eject heat from power supplies 8 into relatively cool front section 24 where fans 6 of miners 20 the circulate that air to the relatively warm rear section 26.

Advantageously, the plurality of data miners 20 are used to circulate air in data center 10, providing cooling without the use of external fans or air conditioning equipment. Advantageously, ambient air thus may be used as cooling air. For example, without using air conditioning equipment to maintain the temperature inside container 12 at about 22° C. (72° F.), ambient air proximate the outside of container 12 is used to cool data center 10 and components thereof such as miners 20. Thus, even outside air at particularly cold temperatures of about 0° C. (32° F.) or particularly hot temperatures of about 40° C. (104° F.) may be used to leverage the design of data center 10 and is drawn into relatively cool front section 24 of container 12, e.g. through louvers 28, so that miners 20 operate within preferred operating temperature range, e.g., 0-40° C. (32-104° F.). Data center 10 preferably is operated in a location where ambient temperatures throughout the year do not typically fall outside the preferred operating temperature range of miners 20. Preferably, a control system may be employed to monitor the operating temperature of miners 20 and to cease operation of a miner 20 when its temperature is less than 0° C. (for example dropping as low as −40° C. due to very cold air available for cooling) or greater than 40° C. (for example as high as 85° C. due to very hot air available for cooling).

Advantageously, each data miner 20 provides necessary airflow for its own sufficient cooling, and thus data center 10 can be scaled to essentially any specification. Moreover, because of the modular design of data center 10 with a plurality of miners 20, a failure of any particular miner 20 (or cooling fan thereof) does not impact the cooling of other miners 20 in data center 10 because each miner 20 has its own cooling fan and thus provides its own cooling air flow. Also, this occurs without the need of external cooling or external fans. In contrast, the traditional design of a data center requires air conditioning and/or external fans to compensate for scaling of equipment.

Also, advantageously, in some embodiments, some relatively warm air from rear section 26 may be recirculated to mix with the relatively cool air in front section 24 so as to achieve a desired relative humidity. Because rear section 26 is at a relatively higher static pressure compared to front section 24, no mechanical air handling is needed to provide such recirculation. Rather, only a path need be created such as by providing an opening of appropriate size in barrier wall 22. Optionally, a control system may be used to regulate the recirculation of relatively warm air. Thus, because relatively warm air from rear section 26 may be recirculated to front section 24, it is possible to operate data center 10 at even colder outdoor temperatures, such as outside air as low as about −18° C. (0° F.) or even lower, because once that very cold air enters front section 24 it can be warmed with the recirculated air from rear section 26 prior to flowing through miners 20. Thus, miners 20 could still be operated within their preferred operating temperature range despite the outdoor air having a temperature lower than the minimum of that range.

Moreover, although the miners 20 may have an operating temperature range of 0-40° C. (32-104° F.), acceptable outside air temperatures could be as low as −23° C. (−10° F.) or even lower, because the outside air will be used to cool miners 20 but will not actually maintain miners 20 at that low temperature. Of course, miners 20 (not to mention other components of data center 10) generate considerable heat while operating.

In some embodiments, a temperature difference between the relatively cool front section 24 and the relatively warm rear section 26 is at least 5° C., at least 10° C., at least 20° C., at least 30° C., or at least 40° C.

In some embodiments, to provide enhanced cooling as compared to what is provided by fans disposed on or in miners/data loggers 20, additional fans may be provided to create further air flow to expel relatively warm air from rear section 26, thereby expanding the temperature range over which the miners 20 may be used while reducing wear or stressing of miners 20.

Container 12 may be located proximate a hydroelectric facility, so that inexpensive hydropower may be used to power the miners 20. In an exemplary embodiment, container 12 is disposed in an outdoor environment near the hydroelectric power plant. Preferably, in general, container 12 is sited near a source of power for miners 20 and adjacent a substation. For example, by operating data center 10 near the substation of a hydroelectric plant, data center 10 may be connected to that substation for power. Preferably, the substation has alternate sources of power from which data center 10 may draw power. For example, the substation may permit data center 10 preferably to draw power from a hydroelectric plant or, alternatively, from the electric power grid when power from the hydroelectric plant is temporarily unavailable such as due to maintenance or federally-mandated downtimes.

Preferably, each miner 20 in container 12 is provided with power, internet access, and/or relatively cool air. In addition, preferably control systems in container 12 ensure the provision of power, internet access, and/or relatively cool air to miners 20 and provide remote monitoring thereof to ensure proper functioning.

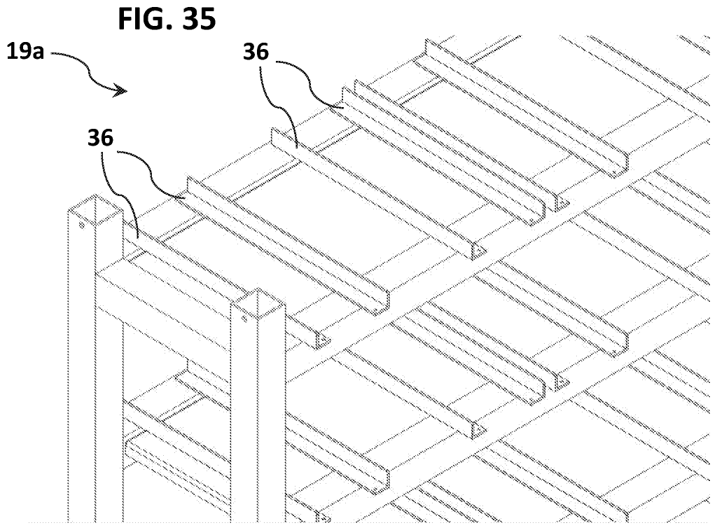

As shown for example in FIGS. 26 and 35, each miner 20 fits within a space defined by a pair of opposing angles 36 (which, for example, may be one inch by one inch in width) and is retained in that space using a lateral support plate 37 fastened to angles 36 such that miner 20 is pushed toward and sealed to barrier wall 22a, 22b. Additional space provided adjacent thereto is configured and dimensioned to receive a power supply 8 for each miner 20.

Advantageously, doors 34 are disposed on both ends of container 12. Advantageously, even when a door 34 is opened to relatively cool front section 24, the relatively warm rear section 26 remains sealed.

In a preferred exemplary embodiment, the electrical infrastructure of data center 10 includes two three-phase sources that enter container 12 at 400 V three phase and feed two panel boards. Each of those panel boards feed a number of 30 amp, three-phase breakers, and each breaker feeds a 10-4 (10 gauge, 4 conductor) cable (one conductor of the four feeds four miners). Each power receptacle 23a is provided 240 V single phase, and feeds each miner 6 amps. Each of the panels also feeds 240 V LED bulbs on roof 30 inside container 12 in front and rear sections 24, 26. Preferably, twenty-five 10-4 cables for feeding power to miners 20 come out of the two panels, extend through the partition wall, and into a cable tray in rear section 26, and feed back out through the partition wall into cable troughs 23 where the outlets are located. A two-pole breaker may be provided to feed a small transformer disposed in rear section 26, for providing a 110 V power supply to additional outlets such as for tools, laptop computers, and a network rack. Another three-pole breaker may be provided for feeding a control cabinet; the control cabinet is primarily the power feed for five variable frequency drives which modulate AC current to generate different motor speeds, enabling exhaust fans 32 to be run from 0 to 120%. Preferably, the control cabinet controls the variable frequency drives (VFDs), which in turn control the speed of exhaust fans 32 which may be varied as a function of temperature and pressure inside container 12, and provides monitoring of temperature, humidity, and pressure using sensors which are read by a programmable logic controller (PLC). A proportional-integral-derivative (PID) controller may be used to provide control loop feedback. The speed of exhaust fans 32 preferably is adjusted to maintain negative exhaust pressure in the exhaust cavity formed by rear section 26, preferably maintaining exhaust pressure from near 0 to about 0.35 inches of water. The control parameter from which fan speed may be adjusted, for example, may be the temperature or pressure inside rear section 26. Preferably, the network rack provides internet access to miners 20 and to the PLC; it may be fed from a cable or cellular modem. The various systems preferably permit operation of miners 20 as well as remote monitoring and control of the control system.

Miners 20 may be managed, for example, by a mining pool, which for example comprises a cooperative group of miners 20 operating together to pool resources by sharing computing power over a network, with the pool then sharing mining rewards to flatten revenues to operators of miners 20 in the pool. A mining pool, for example, may pay an operator proportional to the amount of computing power that the operator provides to the pool (which is governed by the number of miners operated by that operator), thereby providing a more constant or revenue stream over time.

Both power and ethernet need to be coupled to each miner 20. To that end, although not shown, in a preferred embodiment a first cable tray is disposed inside container 12 proximate roof 30 and in relatively cool front section 24 for accommodating ethernet cables for miners 20. A second cable tray is disposed inside container 12 proximate roof 30 and in relatively warm rear section 26 for accommodating power cables for powering miners 20 and associated control equipment.

In some embodiments, exhaust fans 32 each incorporate a louver (not shown) that may be opened or closed, so that when a fan 32 is pulling air out of container 12 the louver is in the open state and when not, the louver is closed so that there is no backdraft into container 12. Moreover, exhaust fans 32 preferably incorporate drains so that rain water or other moisture thereon is prevented from entering container 12.

In an alternate embodiment, fans 32 may be disposed on container 12 instead to deliver air to (rather than exhaust it from) relatively cool front section 24, with air in relatively warm rear section 26 being exhausted from (rather than drawn into) container 12 through louvers 28.

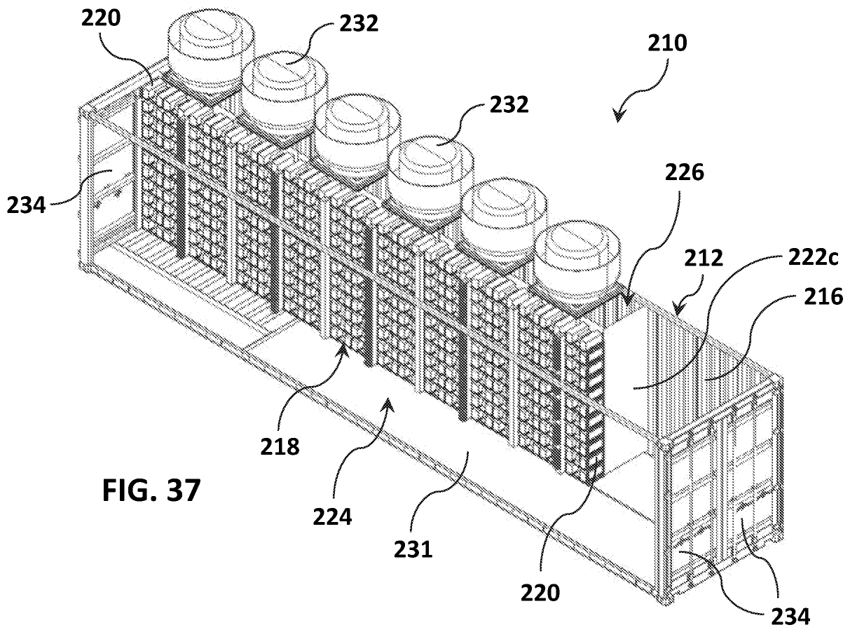

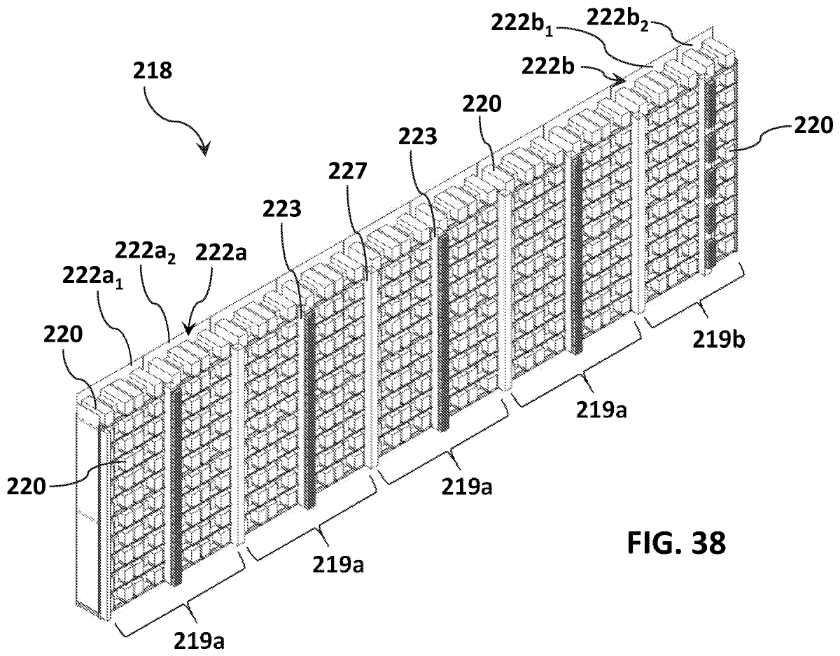

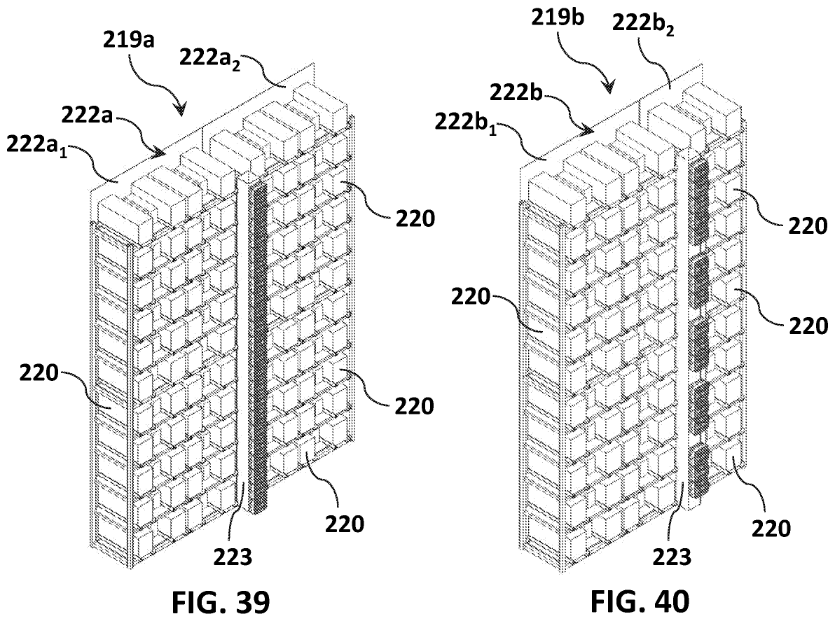

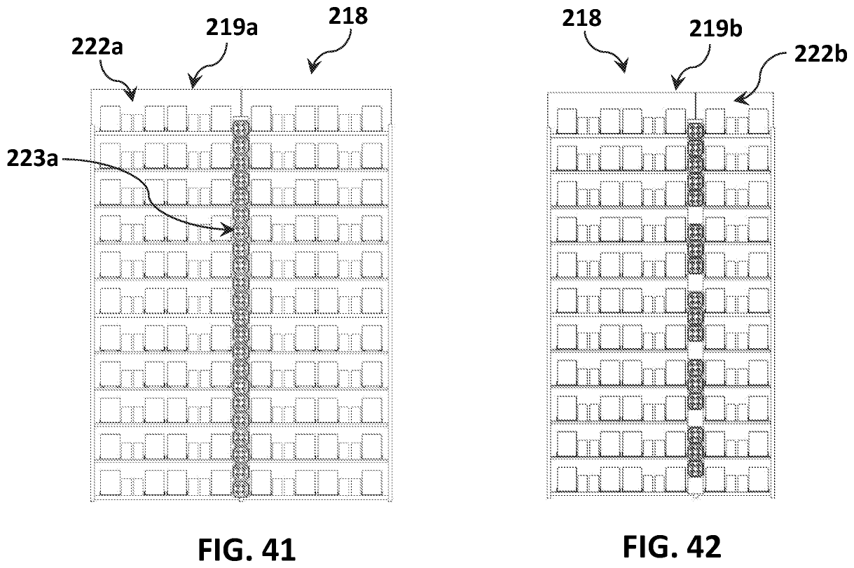

As shown in FIGS. 37-42, in yet another embodiment, a data center 210 comprises a container 212 with a front side or wall (not shown but similar to data center 10 and comprising a plurality of louvers for permitting air intake), a back side or wall 216, and a rack assembly 218 with at least one rack 219a, 219b. Each rack 219a, 219b preferably has at least one computing unit 220, which may be a miner or other computer, a processing unit, or a data logger, mounted thereon, a barrier wall 222a, 222b, and a power cable trough 223 with power receptacles 223a for coupling to computing units 220 so as to provide power thereto. A network cable trough 227 also may be provided so that computing units 220 may be supplied with network connections. Barrier walls 222a, for example, may be provided in sections 222a₁, 222a₂ for ease of installation. Similarly, barrier walls 222b may be provided in sections 222b₁, 222b₂, with section 222b₂ having a smaller width than section 222b₁. Preferably, barrier walls 222a, 222b are disposed generally parallel to the front side of container 212 and, along with a barrier wall 222c disposed generally transverse to the front side of container 212 and back side 216, separate a front section 224 where relatively cool air is present from a rear section 226 where relatively warm air is present. Container 212 further includes a roof (not shown but similar to container 12), a floor 231, at least one fan 232 operated as an exhaust fan and disposed on the roof, and lockable doors 234 on both ends thereof.

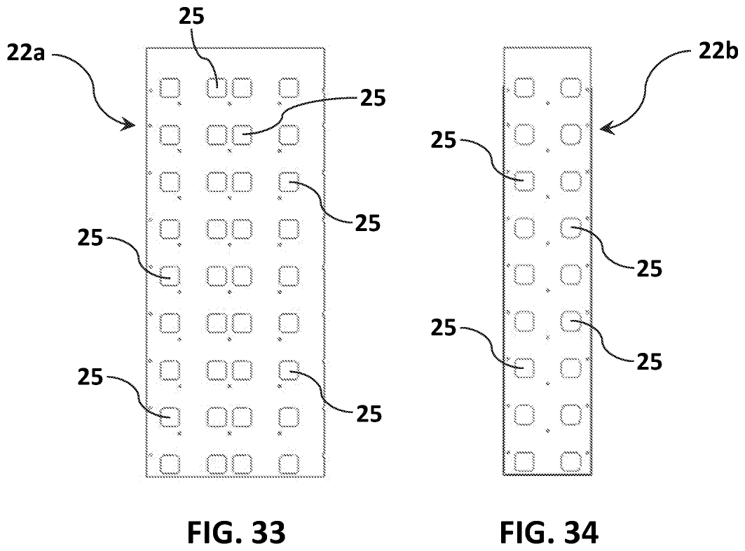

The embodiment of data center 210 shown in FIGS. 33-34 includes four hundred and eighteen (418) miners 220 distributed in thirty-eight (38) columns and eleven (11) rows, arranged on rack assembly 218 and exhausting through barrier walls 222a, 222b. Notably, although data center 210 includes substantially more miners 220 than data center 10 with miners 20, both are accommodated in the same size “High Cube” shipping container and rack assembly 218 is about the same length as rack assembly 18 (the former being about one inch longer).

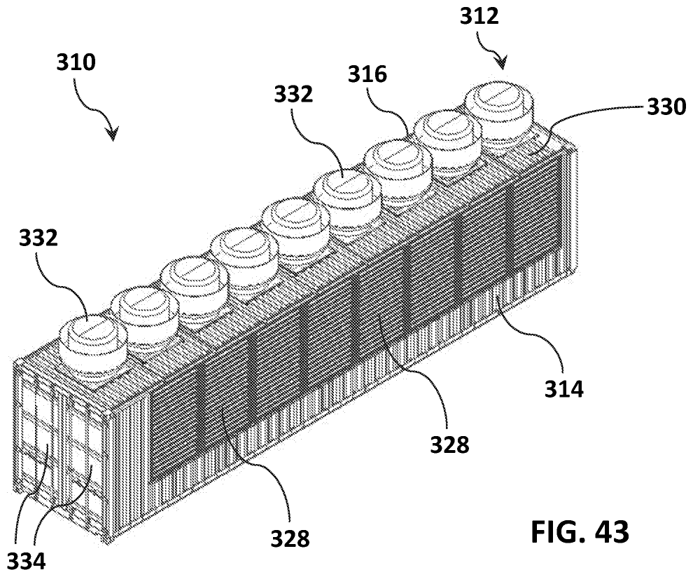

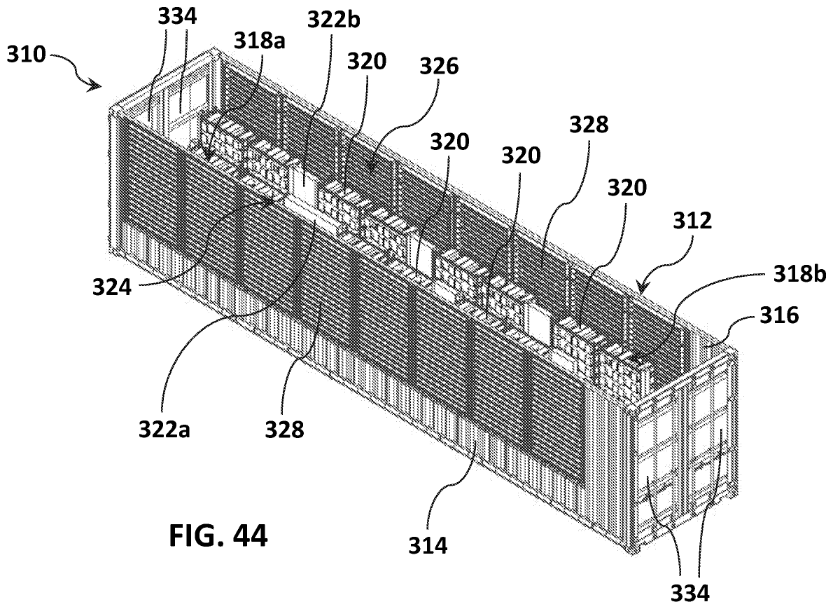

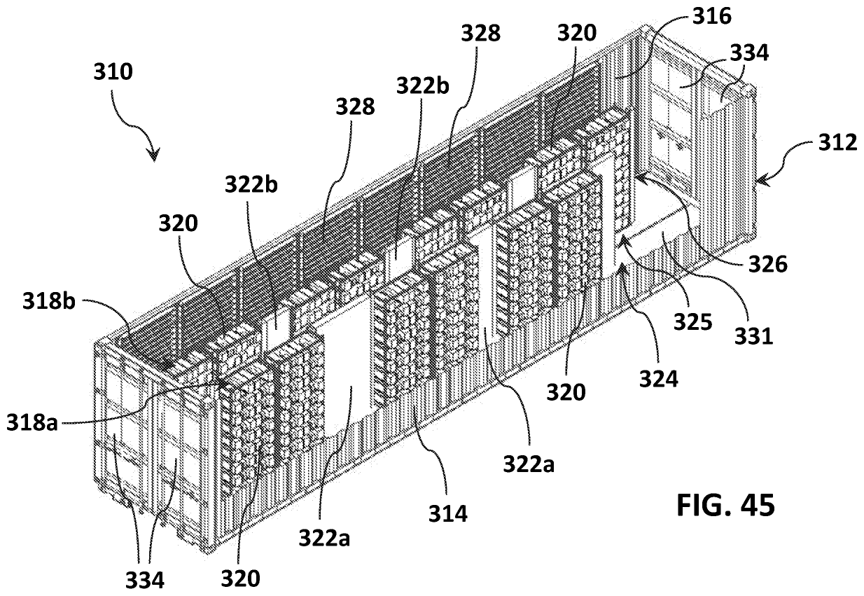

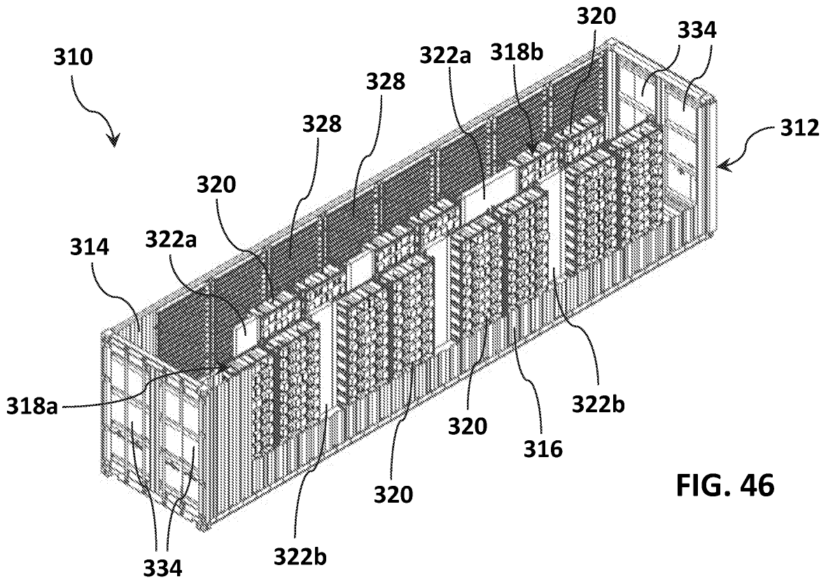

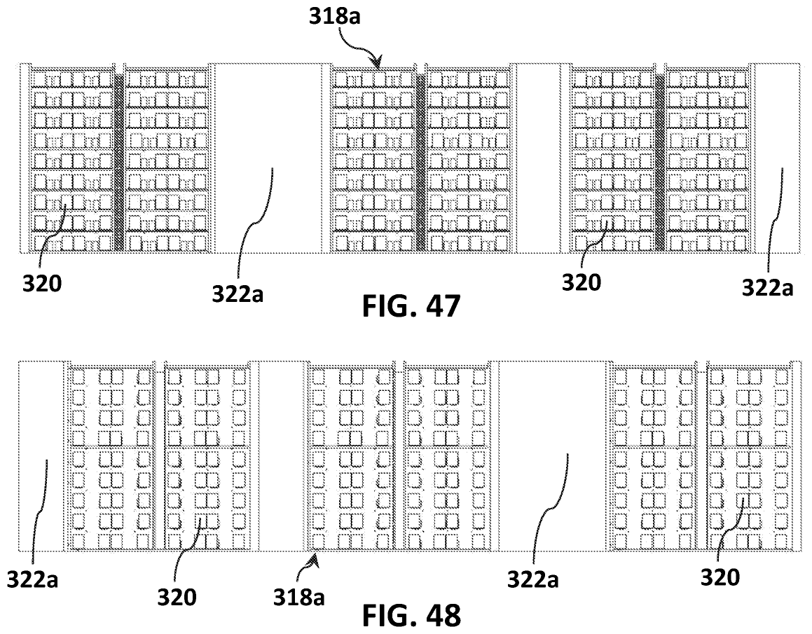

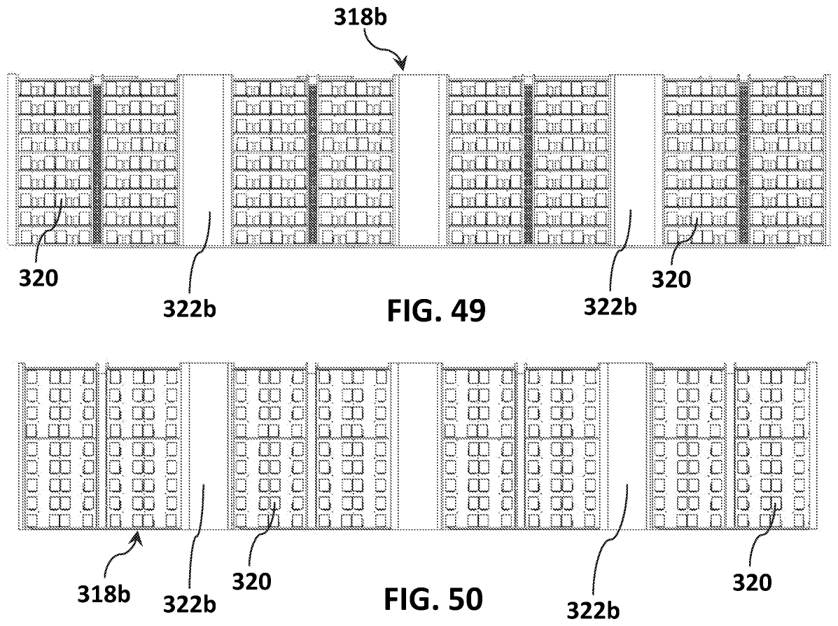

As shown in FIGS. 43-50, in still another embodiment, a data center 310 comprises a container 312 with a front side or wall 314 comprising a plurality of louvers 328 for permitting air intake, a back side or wall 316 comprising a plurality of louvers 328 for permitting air intake, and rack assemblies 318a, 318b with at least one rack as shown for example in prior embodiments. Each rack preferably has at least one computing unit 320, which may be a miner or other computer, a processing unit, or a data logger, mounted thereon, and barrier walls 322a, 322b. Barrier walls 322a, 322b, for example, each may be provided in sections for ease of installation. Data center 310 has a front section 324 disposed between (i) rack assembly 318a with its associated barrier wall 322a and (ii) louvers 328 on front side 314. An intermediate section 325 of data center 310 is disposed between (i) rack assembly 318a with its associated barrier wall 322a and (ii) rack assembly 318b with its associated barrier wall 322b. Data center 310 also has a rear section 326 disposed between (i) rack assembly 318b with its associated barrier wall 322b and (ii) louvers 328 on back side 316. In other words, data center 310 may be provided with two relatively cool sections and one relatively warm section disposed therebetween.

Preferably, barrier wall 322a is disposed generally parallel to front side 314 of container 312 and separates front section 324 where relatively cool air is present from intermediate section 325 where relatively warm air is present. Similarly and preferably, barrier wall 322b is disposed generally parallel to back side 316 of container 312 and separates rear section 326 where relatively cool air is present from intermediate section 325 where relatively warm air is present. Container 312 further includes a roof 330, a floor 331, at least one fan 332 operated as an exhaust fan and disposed on roof 330 to exhaust relatively warm air from intermediate section 325, and lockable doors 334 on both ends thereof. The embodiment of data center 310 may be accommodated in a “High Cube” shipping container.

In one embodiment, rack assemblies 318a, 318b with respective barrier walls 322a, 322b extend from floor 331 to roof 330, and from a first end of container 312 proximate doors 334 to a second end of container 312 proximate other doors 334. In other words, relatively warm air drawn through miners 320 (e.g., just like miners 20) may be substantially trapped in intermediate section 325 for exhausting from container 312 through at least one exhaust fans 332. In the preferred exemplary embodiment, at least one exhaust fan 332 is disposed on roof 330 so that relatively warm air is exhausted therethrough, but in an alternate embodiment at least one exhaust fan 332 is disposed on a front and/or rear side 314, 316, respectively, of container 312.

Each barrier wall 322a, 322b has a plurality of openings 350a, 350b that each are in communication with a back end of a housing of a miner 320 (e.g., just like miners 20). Thus, relatively cool air from front section 324 may be (1) drawn into each miner housing by the individual miner (which miner is coupled to rack assembly 318a and barrier wall 322a just like miners 20), (2) then cools components of miner 320, and (3) then is exhausted into relatively warm intermediate section 325 where the warmed air ultimately may be exhausted through exhaust fans 332 disposed on roof 330 and preferably spanning substantially the entire length thereof. Similarly, relatively cool air from back section 326 may be (1) drawn into each miner housing by the individual miner fan (which miner is coupled to rack assembly 318b and barrier wall 322b just like miners 20), (2) then cools components of miner 320, and (3) then is exhausted into relatively warm intermediate section 325 where the warmed air ultimately may be exhausted through exhaust fans 332 disposed on roof 330 preferably above intermediate section 325.

While various descriptions of the inventions are described above, it should be understood that the various features can be used singly or in any combination thereof. Therefore, the inventions are not to be limited to only the specifically preferred embodiments depicted or otherwise described herein. For example, computing units 20, 220 may traverse the barrier walls (such as protruding partially through the walls and thus protrude into both front section 24 and rear section 26). In addition, in an alternate exemplary embodiment, computing units 20, 220 may primarily or only extend in rear section 26, so long as cooling air still can flow therethrough from the relatively cool portion of container 12. While the use of Bitcoin miners is discussed in detail herein, other cryptocurrency miners may be employed such as for other types of digital currency including but not limited to Litecoin, Dogecoin, Electroneum, Ravencoin, Ethereum, GRAFT, and various types of stablecoin. Also, various types of computing may be employed by computing units 20 such as floating point operators (FLOPS), graphics rendering, or artificial intelligence such as machine learning.

Further, it should be understood that variations and modifications within the spirit and scope of the inventions may occur to those skilled in the art to which the inventions pertain. Accordingly, all expedient modifications readily attainable by one versed in the art from the disclosure set forth herein that are within the scope and spirit of the inventions are to be included as further embodiments of the inventions. The scope of the inventions is accordingly defined as set forth in the appended claims.

What is claimed is:

1. A data center comprising:
an enclosed space;
a support disposed in the enclosed space;
a plurality of cryptocurrency miners disposed on the support;
a barrier wall separating the enclosed space into a first portion on a relatively cool side and a second portion on a relatively warm side;
wherein the cryptocurrency miners each comprise a miner fan for circulating air from the first portion; and
wherein the cryptocurrency miners are each disposed so that air moved by the miner fan is exhausted into the second portion.

2. The data center of claim 1, further comprising at least one exhaust fan for exhausting air from the second portion.

3. The data center of claim 1, wherein the enclosed space comprises a shipping container.

4. The data center of claim 1, wherein the support comprises a rack assembly.

5. The data center of claim 1, further comprising louvers for permitting air circulation into the first portion.

6. The data center of claim 5, wherein the louvers comprise at least one barrier for preventing foreign objects from entering the enclosed space.

7. The data center of claim 6, wherein the at least one barrier comprises a screen.

8. The data center of claim 7, wherein the screen is configured and dimensioned to prevent birds from entering the enclosed space.

9. The data center of claim 5, wherein the louvers comprise at least one panel filter for removing airborne particulate and coolant mist from air entering the enclosed space.

10. The data center of claim 1, wherein a temperature difference between the first portion and the second portion is at least 10° C. during operation of the miners.

11. The data center of claim 1, wherein a temperature difference between the first portion and the second portion is at least 20° C. during operation of the miners.

12. The data center of claim 1, wherein the cryptocurrency miners are configured to mine Bitcoin.

13. The data center of claim 1, further comprising an aperture for permitting air to transfer from the second portion to the first portion.

14. The data center of claim 13, wherein the aperture permits control of relative humidity in the first portion.

15. The data center of claim 1, further comprising a second barrier wall separating the enclosed space into a third portion on a relatively cool side and the second portion on a relatively warm side, wherein the third portion is distinct from the first portion.

16. A data center comprising:
an enclosed space;
a first support disposed in the enclosed space;
a plurality of cryptocurrency miners disposed on the first support;
a second support disposed in the enclosed space;
a plurality of cryptocurrency miners disposed on the second support;
a first barrier wall separating the enclosed space into a first portion on a relatively cool side and a second portion on a relatively warm side;
a second barrier wall separating the enclosed space into a third portion on a relatively cool side and the second portion on a relatively warm side;
wherein the cryptocurrency miners on the first support each comprise a miner fan for circulating air from the first portion;
wherein the cryptocurrency miners on the second support each comprise a miner fan for circulating air from the third portion; and
wherein the cryptocurrency miners are each disposed so that air moved by the miner fan is exhausted into the second portion.

17. A method of cooling a data center with a plurality of cryptocurrency miners, and with each miner comprising a miner fan, the method comprising:
disposing the miners in an enclosed space;
drawing relatively cool air into the enclosed space on a first side of a barrier disposed therein;
operating the miner fans to draw the relatively cool air into and through the miners, with the relatively cool air being warmed by convective heat transfer inside each miner, and the relatively cool air thereby being warmed to become relatively warm air; and
exhausting the relatively warm air on a second side of the barrier opposite the first side.

18. The method of claim 17, further comprising:
drawing the relatively warm air out of the second side of the enclosed space using at least one exhaust fan.

19. The method of claim 17, wherein the relatively cool air is drawn into the enclosed space through louvers.

20. The method of claim 17, wherein the louvers comprise at least one barrier for preventing foreign objects from entering the enclosed space.

21. The method of claim 17, further comprising:
removing airborne particulate and coolant mist from air entering the enclosed space by passing the air through at least one panel filter.

22. The method of claim 17, wherein a temperature difference between the first side of the barrier and the second side of the barrier is at least 10° C. during operation of the miners.

23. The method of claim 17, wherein a temperature difference between the first side of the barrier and the second side of the barrier is at least 20° C. during operation of the miners.

24. The method of claim 17, wherein the cryptocurrency miners are configured to mine Bitcoin.

25. The method of claim 17, further comprising:
disposing the miners substantially on the first side.

26. The method of claim 17, further comprising:
disposing the miners substantially on the second side.

27. The method of claim 17, further comprising:
disposing the miners intermediate the first side and the second side.

28. The method of claim 17, further comprising:
disposing the miners to protrude into the first side and the second side.

29. The method of claim 17, further comprising:
recirculating the relatively warm air to the first side.

30. The method of claim 29, wherein the relative humidity of the relatively cool air on the first side is adjusted when the relatively warm air is recirculated to the first side.

31. The method of claim 29, wherein a static pressure difference between the first side and the second side causes relatively warm air from the second side to flow through an opening into the first side.

32. The method of claim 29, wherein the recirculating occurs without mechanical air handling.

33. The method of claim 17, further comprising:
drawing relatively cool air into the enclosed space on a first side of a second barrier disposed therein;
operating the miner fans to draw the relatively cool air into and through the miners, with the relatively cool air being warmed by convective heat transfer inside each miner, and the relatively cool air thereby being warmed to become relatively warm air; and
exhausting the relatively warm air on a second side of the second barrier opposite the first side;
wherein the relatively warm air is disposed between the second side of the first barrier and the second side of the second barrier.
